(19) United States
(12) Patent Application Publication
(10) Pub. No.: US 2011/0173559 A1
(43) Pub. Date: Jul. 14, 2011

(54) METHOD AND SYSTEM FOR PUBLISHING AN ONLINE POST FROM A DEVICE

(76) Inventors: William Benjamin Schaefer, IV, San Francisco, CA (US); Michael Philip Lasmanis, San Francisco, CA (US); Jason James Kelly, Long Beach, CA (US); John Birchfield, Ben Lomond, CA (US); Leith Leedom Alan, Palo Alto, CA (US); Michael Ayhan, San Francisco, CA (US)

(21) Appl. No.: 12/687,087

(22) Filed: Jan. 13, 2010

(51) Int. Cl. G06F 3/048; G06F 17/30

(52) U.S. Cl. 715/780; 707/802; 715/833; 707/E17.044

(57) ABSTRACT

A method and system for publishing an online post from a device that includes obtaining information for a post and receiving user input from a single-interaction interface on the device. The received user input initiates selecting a context descriptor for the post based on the user input; creating the post from the obtained information and selected context descriptor, and sending the post to a post database.

### TECHNICAL FIELD

This invention relates generally to the web-publishing field, and more specifically to a new and useful method and system for publishing an online post from a device in the web-publishing field.

### BACKGROUND

There are currently many avenues for the public to contribute content to the internet: blogging platforms, review sites, media hosting sites, social networks, micro-blogging platforms, crowd-sourced projects (e.g., Wikipedia), etc. However, much of this content is in a personal or subjective format, which makes it difficult for information to be analyzed from a mass collection of posts. What one person writes cannot be correlated in any obvious way to what another person writes. Furthermore, providing content requires a user to invest considerable time to write and navigate an interface to upload content. This not only is burden to the user, but also indirectly to the system using posted content because less information can be gathered. Thus, there is a need in the web-publishing field to create a new and useful method and system for publishing an online post from a device. This invention provides such a new and useful method and system.

### BRIEF DESCRIPTION OF THE FIGURES

FIG. 1 is a schematic representation of a method of a preferred embodiment of the invention;

FIG. 2 is a flowchart representation of a method of a preferred embodiment of the invention;

FIGS. 3A and 3B are variations of single-interaction interfaces of a preferred embodiment; and

FIG. 4 is a schematic representation of a system of a preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method for Publishing an Online Post

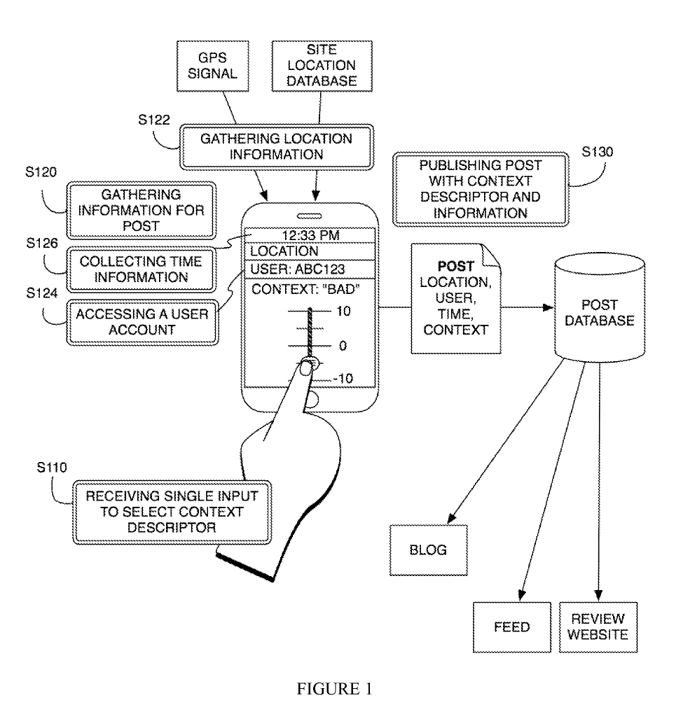

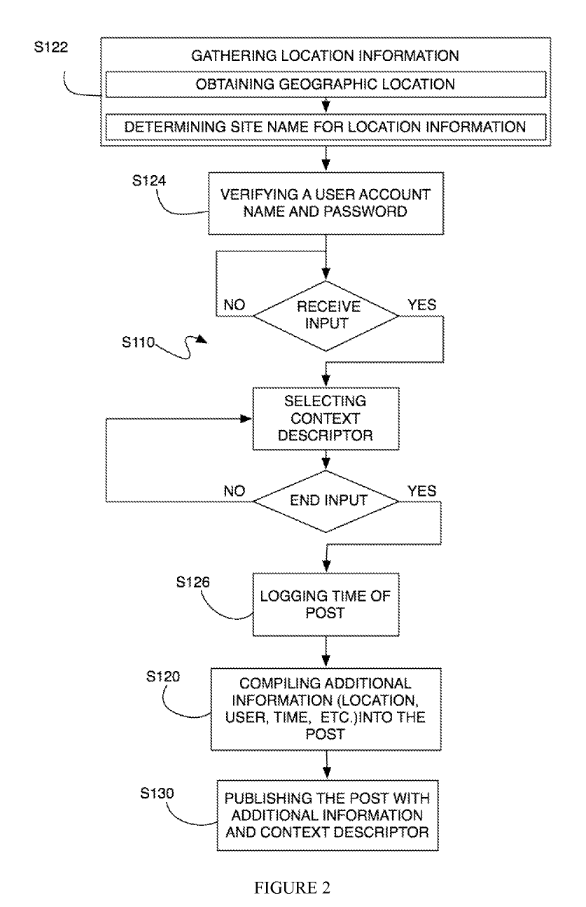

As shown in FIGS. 1 and 2, a method for publishing an online post of the preferred embodiment includes receiving a single input that selects a context descriptor S110, and—upon receiving the single input—gathering additional information of a post S120, and publishing the post with the selected context descriptor and additional information S130. The method functions to minimize the amount of human input required to create an informative post. The post is any suitable entry that is compiled with a collection of entries. The posts are preferably hosted on a website, but may alternatively be hosted locally within an application or local database or server. A post is preferably used as a form of reviewing, but may additionally or alternatively be used as a form of micro-blogging, data collection, comments, messaging, gaming, and/or any suitable application. In one embodiment, Step S120 includes the step of collecting the location of a device S122, verifying a user account S124, and collecting time at the time of creating a post S126. These sub-steps function to provide answers to some of the basic questions in a post such as where, who, and when. In combination with the context descriptor this information provides a rich and complete story with only a single input from a user. The method is preferably applicable for on-site reviewing of businesses (e.g., restaurants), micro-blogging, and/or any other suitable application.

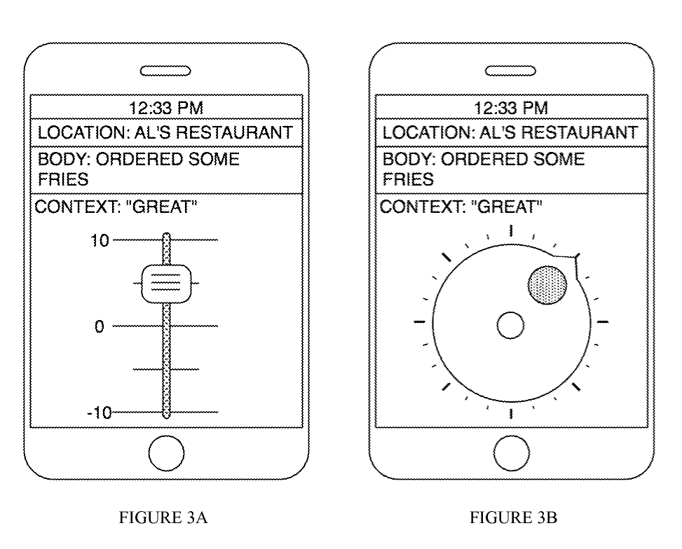

Step S110, which includes receiving input a single input that selects a context descriptor, functions to use a from a single-interaction interface as a multiple-purpose input for gathering information (e.g., location and time), entering content for a post, and publishing the post. The single-interaction interface preferably receives only a single action of a user as the single input. In one preferred variation, as shown in FIG. 3A, the single-interaction interface receives a sliding input from a user. In other variations, the single-interaction interface may be rotary dial (shown in FIG. 3B), a pressure sensor, sound amplitude sensor, selectable menu, touch sensitive grid, or any suitable interface that can select determinable information. The single-interaction interface is preferably a virtual control displayed on a touch sensitive screen of a device. The single-interaction interface may alternatively be a physical control such as an analog button. The input received is preferably used to initiate several steps that result in a published post.

A context descriptor is preferably selected when the single input is received. The selection of a context descriptor, which is preferably part of Step 110, is preferably based on the action of the single-interaction interface and preferably sets a variable value. The context descriptor preferably maps to a phrase, a rating, an item name, a feeling, a picture (such as an emoticon), or to any suitable form of media. Selecting a context descriptor preferably includes selecting a context descriptor amongst a plurality of context descriptors (such as strongly dislike, dislike, neutral, like, and strongly like). In one variation, the single-interaction interface is a linear slider, wherein the position of the slider along a linear path selects a particular context descriptor (e.g., “like”). In another variation, the single-interaction interface is a rotary dial, wherein the position of the dial along an arcuate path selects a particular context descriptor (e.g., “11”). In yet another variation, the single-interaction interface is a two-axis “graph”, wherein the position along the graph along both the X-axis and the Y-axis selects two particular context descriptors (e.g., “alone—good time” and “with friends—could be better”). The selection of a context descriptor is preferably amongst a discrete number of context descriptors (e.g., five context descriptors), but may be amongst any number of context descriptors (including a continuous scale). The context descriptors are preferably arranged along a gradient scale from a negative descriptor (e.g., “dislike”) to a positive descriptor (“like”), but may be randomly arranged, strategically arranged in a so-called “tag cloud”, or arranged in any other suitable pattern. In one variation, the number of context descriptors and the actual context descriptors may be adjusted, modified, or created by the user. In other variations, the number of context descriptors and/or the actual context descriptors may be predetermined. In yet other variations, the number of context descriptors and the actual context descriptor may be automatically adjusted or changed according to the location, time, and/or user. For example, the context descriptors for a restaurant may relate to the quality of the food (e.g., “tasty”, “disgusting”) and for a doctor's office may relate to quality of service (e.g., “timely and professional”, “rude and hasty”).

Step S120, which includes gathering information for a post, functions to automatically retrieve additional information that will be included in a post. As described above, Step S120 preferably includes the steps of collecting location of a device S122, verifying a user account S124, and collecting time at the time of creating a post S126. The sub-steps of S120 may be performed in any suitable order including being preemptively gathered before receiving an input as shown in FIG. 2. While the preferred embodiment includes the three sub-steps, Step S120 may alternatively include any suitable combination of the steps or additional steps. As examples of alternative sub-steps, media files may be selected to be included in the post, text may be written or selected for inclusion, web links may be added, and any suitable information may be included in the post.

Step S122, which includes collecting location of a device, functions to determine where a post is created. A Global Positioning Service (“GPS”) component of a device preferably determines the position of the device. The position of the device may alternatively be determined through wireless triangulation, IP address location, and/or any suitable technique. Additionally, business or location information is preferably used in combination with the geographic location to determine a site name. A site name may be titles of businesses at that geographic location, such as a restaurant name, a place of interest such as a park name, personal location title such as ‘home’, or any suitable description of a location. Due to inaccuracies of positioning techniques and the density of possible sites, a selectable list of nearby sites is preferably listed so that a user may select the appropriate site name. Additionally, the method may record a user selected site name and corresponding geographic information in a user site map. During subsequent posts made in substantially the same location, the step of identifying a site name may include accessing the user site map to automatically select a previously identified site name. These steps related to the user site map function to allow commonly visited locations to be automatically selected when the user is near them. In this way, the most probable site name is chosen for a given location. As an example, a user may select a particular restaurant when in a geographic location. The next time the user is near the restaurant that site name will preferably be automatically selected since a record of the user visiting that restaurant has been recorded. As an alternative, the location information may be adapted for any suitable application such as making the location information relative to a fixed position, a street address, a distance from a fixed point, and/or any other suitable location description.

Step S124, which includes verifying a user account, functions to use user credentials to determine the author or source of the post. User account credentials are preferably saved or accessed from the device, but may alternatively be required to be entered by the user prior to sending a post to the central server. User credentials preferably include a username and a password, but may alternatively include any suitable description and/or authorization technique for a user. In one variation, the user is determined based on the identification of the device (and not the actual identification of the user). In other variations, the user may be determined in any suitable manner.

Step S126, which includes collecting time at the time of creating a post, functions to include temporal information from the device. The time preferably provides additional context to the post. Similar to how location information is converted to site name information, time information can be converted to event information. For example, if a person is at a restaurant as determined by Step S122 and the time is near noon time, then an assumption that the person is having lunch can be made. This may be particularly applicable to a restaurant review (one potential application of the method of the preferred embodiment). Additionally, accessing time logged data, such as a personal calendar may be used in cooperation with the collected time to assign an event name. In one example, a post may be labeled as “business meeting” if a business meeting is scheduled in a personal calendar at the same time as the collected time.

Step S130, which includes publishing the post with the selected context descriptor and additional information, functions to compile information of the post and send the post for publishing. Preferably the information obtained in Step S110 and Step S120 is preferably combined. The creation of a post is preferably initiated at the termination of the interaction with the single-interaction interface, which preferably occurs when a user releases contact with the interface. Alternatively, the creation of a post may be initiated after a timed interval has transpired since the last change in the single-interaction interface. For example, if the user pauses during the selection of a context descriptor for three seconds then the post may be created. Any suitable rule based on interaction with the single-interaction may alternatively be used for when to create and send the post. The post is preferably sent to a post database which will in effect publish the post for distribution via the internet. Sending the post to a post database preferably saves the post within a collection of posts. The collection of posts preferably residing in a database (or a plurality of locations). The post database is preferably located remotely on a server accessible through an internet connection, but may alternatively be a local database. The post may alternatively or additionally be submitted to a database of an outside datahost such as Facebook Twitter, or Yelp. The post database may be used for a plurality of applications. The posts are preferably used as a form of website entry, such as a blog post or an online review. The posts may alternatively be used as data sources, such as for business applications of tracking performance or other metrics captured with the single-interaction interface. The posts may alternatively be published by sending any suitable message such as an email, text message, or data communication to any suitable system.

### 2. System for Publishing a Post

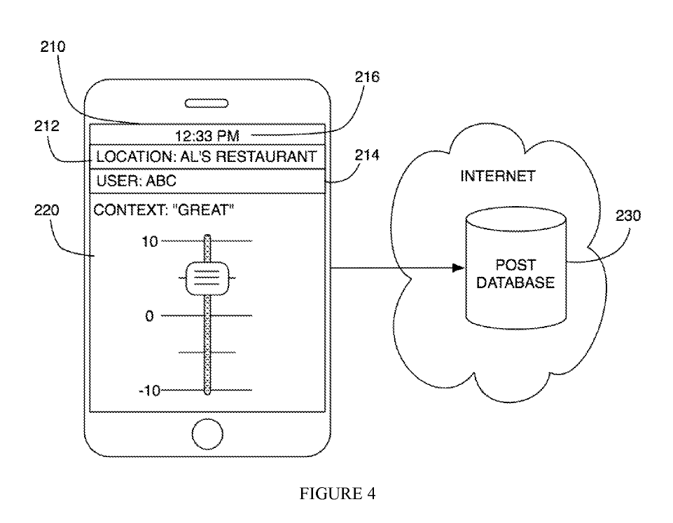

As shown in FIG. 4, a system for publishing a post of the preferred embodiment includes a post content system 210, a single-interaction interface 220, and a post database 230. The system of the preferred embodiment functions to enable a post to be populated with content and posted with only one user interface. In one embodiment content is preferably accessed from various sources automatically on a device. The device is preferably a mobile device such as a smart phone, but may alternatively be any suitable computing device such as a computer. In particular, the system adds relevant site information (location), time of post, the name of the user, and a context descriptor associated with this information. This information preferably allows a user to tell a story with minimal effort. In one exemplary application of creating on-site restaurant reviews, a user can access the system and use the single-interaction interface 220 to say how they feel, which additionally (and automatically) publishes the post. While requiring minimal effort by the user, the post will provide sufficient information to set up the context and thoughts of the user. The system may additionally be adapted to any suitable application and may have additional interfaces such as a text entry field for user created text, a media adding interface, and/or any suitable interface.

The post content system 210 of the preferred embodiment functions to gather the information to be included in a post. The post content system preferably automatically retrieves information from appropriate sources. In one preferred embodiment, the post content system 210 includes a location unit 212, an account manager 214, and a clock 216. The location unit 212 functions to obtain appropriate location information as described above. The account manager 214 functions to verify a user as a source of a post. The account manager 214 may store account information such as a username and password, and submit the account information to a server for verification. The account manager 214 may alternatively authenticate a user. The clock 216 functions to retrieve the time information. The time is preferably retrieved from the device, but may alternatively be fetched from a remote time source accessed over an internet or network connection. The clock may additionally use other information such as a personal calendar to provide time descriptions such as “meeting”.

The single-interaction interface 220 functions to provide a single input that both conveys information added to the post and submits the post for publishing. The single-interaction interface 220 preferably submits the post over an internet connection or alternatively any suitable communication network such as a phone network. The post is preferably submitted to the post database 230. The post may alternatively or additionally be submitted to an outside datahost such as Facebook Twitter, or Yelp. The single-interaction interface 220 is preferably a slider device displayed on a touch sensitive display. In other variations, the single-interaction interface 220 may be virtual (e.g., displayed) or physical (e.g., hardware) rotary dial, pressure sensor, sound amplitude sensor, selectable menu, grid, or any suitable interface to select determinable information. The single-interaction interface 220 may use hardware or user interaction (UI) elements of a device as inputs for the single-interaction interface.

The post database 230 of the preferred embodiment functions to host the posts. The post database 230 is preferably located on a remote server accessible through an internet connection. The post database 230 may alternatively be a local database stored on a computer. The post database 230 may alternatively be operated by an outside party and be part of any datahost such as a social network, review site, or publishing platform.

An alternative embodiment preferably implements the above method in a computer-readable medium storing computer-readable instructions. The instructions are preferably executed by computer-executable components for publishing an online post from a device. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for publishing an online post from a device comprising:
receiving a single input that selects a context descriptor; and
upon receiving the single input:
gathering additional information for a post; and
publishing the post with the selected context descriptor and additional information.

2. The method of claim 1, wherein a plurality of context descriptors are selected from the received single input.

3. The method of claim 1, wherein gathering additional information for a post is performed automatically.

4. The method of claim 1, wherein gathering additional information includes:
gathering location information of the device;
accessing a user account; and
collecting time information at the time of creating the post.

5. The method of claim 4, wherein gathering location information includes identifying a site name for the location information.

6. The method of claim 5, wherein identifying a site name includes receiving a user selected site from a list of sites that are substantially geographically near the physical location of the device.

7. The method of claim 6, further comprising recording a user selected site name and corresponding geographic information in a user site map.

8. The method of claim 7, wherein identifying a site name includes accessing a user site map to automatically select a previously identified site name.

9. The method of claim 1, wherein the context descriptor is a user selected textual description.

10. The method of claim 9, wherein the context descriptor corresponds to a media file.

11. The method of claim 9, wherein selecting a context descriptor includes selecting from a plurality of values within a single-interaction interface.

12. The method of claim 11, wherein the plurality of values represent a range of sequentially ordered positive to negative connotations.

13. The method of claim 12, wherein context descriptor has a numerical value and a related textual description, wherein the numerical value is substantially proportional to the positive-to-negative connotation.

14. The method of claim 11, further comprising changing the plurality of selectable context descriptors based on the location information.

15. The method of claim 11, wherein the post is published upon the completion of receiving input from the single-interaction interface.

16. The method of claim 11, wherein the post is published after a designated time has passed since receiving the single.

17. The method of claim 11, wherein the single-interaction interface is a slider user interaction element of a touch screen interface.

18. The method of claim 17, further comprising:
obtaining geographic location information from a GPS unit of the device;
identifying a site to use as location information of the post, the site being substantially near the geographic location;
accessing a user account;
collecting time information at the time of creating the post; and
wherein the plurality of context descriptor values represent a range of sequentially ordered positive to negative connotations.

19. A system for publishing an online post from a device comprising:
a post content system of the device that populates post content;
a single-interaction interface that is the input of the device for a context descriptor selector and a post submission button; and
a post database that hosts posts and is in communication contact with the device during post submission.

20. The system of claim 19, wherein the post content system includes:
a location unit that gathers location information;
a clock that provides local time to the post;
an account manager that verifies account credentials; and
wherein the single-interaction interface is a scalar value UI element of the device where the value is mapped to a unique context descriptor.
